(19) United States
(12) Patent Application Publication
(10) Pub. No.: US 2004/0146766 A1
(43) Pub. Date: Jul. 29, 2004

(54) Proton electrolyte membranes, methods of making proton electrolyte membranes, and methods of use thereof

(76) Inventors: Siwen Li, Atlanta, GA (US); Meilin Liu, Norcross, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/757,661

(22) Filed: Jan. 14, 2004

Related U.S. Application Data
(60) Provisional application No. 60/439,985, filed on Jan. 14, 2003.

(51) Int. Cl. H01M 8/10; C08J 5/22

(52) U.S. Cl. 429/30; 521/27; 429/33

(57) ABSTRACT

Flexible proton electrolyte membranes, fuel cells, and methods for making membranes are disclosed. One exemplary membrane, among others, includes a flexible proton electrolyte membrane having the characteristic of a proton conductivity of about 1×10⁻⁶ to 1×10⁻¹ S/cm at a temperature range of about 30° C. to about 180° C. and a relative humidity of about 0% to 100%.

### CROSS-REFERENCE TO RELATED APPLICATION

This application claims priority to co-pending U.S. provisional application entitled “Novel proton electrolyte membrane (PEM) based on hybrid inorganic-organic polymers,” having ser. No. 60/439,985, filed on Jan. 14, 2003, which is entirely incorporated herein by reference.

### TECHNICAL FIELD

This disclosure is generally related to fuel cells, and, more particularly, is related to membranes, methods of use thereof, and methods of making thereof.

### BACKGROUND

In an effort to find new energy sources, fuel cells using an electrochemical reaction to generate electricity are becoming an attractive energy alternative. Fuel cells offer low emissions, high fuel energy, conversion efficiencies, and low levels of noise and vibration.

A fuel cell typically includes an anode, a cathode, and a membrane between the anode and the cathode. Typically, a fuel source, such as hydrogen, is introduced at the anode. There, the electrons are catalytically stripped from the hydrogen and are transported via an external circuit across a load to the cathode, while the free protons are conducted from the anode across the membrane to the cathode. At the cathode, the protons are catalytically combined with oxygen (typically from air) to form water to generate electricity.

While simple in concept, fuel cells are quite complex since many systems need to be considered to operate the fuel cell optimally. One of the design challenges in using fuel cells is the high volume of heat it produces while in operation. Thermal management systems (cooling systems) are known for conventional internal combustion engines. Unfortunately, fuel cell powered devices have unique thermal management requirements when compared to internal combustion engines.

Another design challenge includes humidification of the membrane to maintain its proton exchange capability, which limits the temperature at which the membrane can be operated. For example, the water can freeze in cold climate applications (e.g., in an automobile). Another example includes the water vaporizing if the temperature rises above the vaporization point of the water.

Still another challenge encountered while using direct methanol fuel cells (DMFCs), where methanol is the source of hydrogen, includes “methanol crossover.” In particular, methanol is absorbed into the membrane, via water, at the anode and transported, via diffusion, across the membrane to the cathode, where it detrimentally combines with the catalyst and thereby reduces the overall efficiency of the fuel cell.

Thus, a heretofore unaddressed need exists in the industry to address the aforementioned deficiencies and/or inadequacies.

### SUMMARY

Briefly described, embodiments of this disclosure, among others, include membranes, fuel cells, and methods for making membranes. One exemplary membrane, among others, includes a flexible proton electrolyte membrane having the characteristic of a proton conductivity of about 1×10⁻⁶ to 1×10⁻¹ S/cm at a temperature range of about 30° C. to about 180° C. and a relative humidity of about 0% to 100%.

Another exemplary membrane, among others, includes a hybrid inorganic-organic copolymer network having at least one backbone unit having a formula [—O—Si(WX)—O—Si(YZ)-R¹—], wherein each of W, X, Y, and Z is selected from —R²A, —R³, —O—, and —OPO₃H₂, and wherein R¹, R², and R³ are each hydrocarbons.

Another exemplary membrane includes, among others, a membrane formed from mixing components including: at least one hybrid inorganic-organic copolymer network former compound; a first compound including an inorganic acid group; a Si—O—Si inorganic backbone former compound; and a H₃PO₄ compound.

Another exemplary membrane includes, among others, a membrane formed from mixing components including: a bis(alkylalkoxysilyl)-terminated polymer compound; a bis(trialkoxysilyl)-terminated short organic chain compound; a first compound including an inorganic acid group; a Si—O—Si inorganic backbone former compound; and a H₃PO₄ compound.

An exemplary fuel cell includes one of the exemplary membranes described above.

An exemplary method of making a membrane, among others, includes: providing a sol mixture, wherein the sol mixture is formed by mixing compounds selected from group 1 or group 2, wherein group 1 comprises at least one hybrid inorganic-organic copolymer network former compound, a first compound including an inorganic acid group, a Si—O—Si inorganic backbone former compound, and a H₃PO₄ compound, and group 2 comprises a bis(alkylalkoxysilyl)-terminated polymer compound, a bis(trialkoxysilyl)-terminated short organic chain compound, a first compound including an inorganic acid group, a Si—O—Si inorganic backbone former compound, and a H₃PO₄ compound; disposing the mixture on a substrate; heating the mixture; and forming a flexible proton electrolyte membrane having the characteristic of a proton conductivity of about 1×10⁻⁶ to 1×10⁻¹ S/cm at a temperature range of about 30° C. to about 180° C. and a relative humidity of about 0% to 100%.

Other compositions, membranes, methods, features, and advantages will be, or become, apparent to one with skill in the art upon examination of the following drawings and detailed description. It is intended that all such additional compositions, membranes, methods, features, and advantages be included within this description, be within the scope of this disclosure, and be protected by the accompanying claims.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of this disclosure. Moreover, in the drawings, like reference numerals designate corresponding parts throughout the several views.

FIG. 1 illustrates a structure of a hybrid inorganic-organic copolymer.

FIG. 2 illustrates an SEM micrograph showing the cross-sectional view of a fractured copolymer membrane (with composition of OS-50 TEOS-50 GPTS-50 P) sandwiched between two porous carbon electrodes.

FIG. 3 illustrates a ³¹P NMR spectra of two hybrid inorganic-organic membranes with composition of (A) 0 SPS-77 TEOS-23 GPTS-77H₃PO₄ and (B) 0 SPS-50 TEOS-50 GPTS-100H₃PO₄, where SPS is sulfonated phenyltriethoxysilane, TEOS is tetraethyoxysilane, and GPTS is 3-glycidoxypropyltrimethoxysilane. The inset illustrates a spectra of A with magnification of intensity to show the weak peak near −24 ppm.

FIG. 4 illustrates XRD patterns of hybrid inorganic-organic membranes (a) 0 SPS-50 TEOS-50 GPTS-50H₃PO₄ and (b) 9 SPS-50 TEOS-50 GPTS-50H₃PO₄.

FIG. 5 illustrates TGA and DSC curves for a sample with composition of 9 SPS-41 TEOS-50 GPTS-50H₃PO₄ measured in dry air at a heating rate of 5° C./minute.

FIG. 6 illustrates a graph of proton conductivities of hybrid inorganic-organic membranes with different compositions as measured in a dry atmosphere using impedance spectroscopy.

FIG. 7 illustrates a structure of hybrid inorganic-organic copolymer.

FIG. 8 illustrates TGA and DSC curves for three samples as obtained in dry air:

(a) 2 M-3 T-No H₃PO₄, (b) 2 M-3 T-5 P+10% PI, (c) 2 M-3 T-5 P, and (d) 2 M-2 Oc-1 T-5 P, where M is bis(3-methyldimethyoxysilyl)polypropylene oxide, T is bis(triethoxysilyl)octane, P is H₃PO₄, and PI is 2-phenyl imidazole.

FIG. 9 illustrates a ³¹P NMR spectra of two hybrid inorganic-organic membranes with composition of (A) 2 M-3 T-1 S-3 P and (B) 2 M-3 T-5 P, where S is sulfonated phenyltriethoxysilane. The inset is from the spectra of B, with magnification of intensity to show the weak peak near about 11.5 ppm.

FIG. 10 illustrates a graph of proton conductivities of several membranes with different compositions as measured in a dry atmosphere using impedance spectroscopy:

(a) 1 S-1 M-3 T-5.0 P, (b) 1 S-2 M-3 T-5.0 P, (c) 2 M-3 T-5.0 P, (d) 2 M-3 T-4.0 P, and (e) 2 M-3 T-2.5 P.

FIG. 11 illustrates a graph of proton conductivities of a membrane with composition of 2 M-3 T-5 P+10% PI as measured in a dry atmosphere using impedance spectroscopy.

FIG. 12 illustrates proton conductivities of two membranes with different compositions as measured in different relative humidity using impedance spectroscopy. Sample 1: 2 M-2 Oc-1 T-5.0 P. Sample 2: 2 M-2 Oc-1 T-3.0 P. “A” was measured in the water vapor of saturated MgCl₂ aqueous solution, and “B” in the water vapor of saturated LiCl aqueous solution.

### DETAILED DESCRIPTION

In general, membranes, methods of use thereof, methods of making thereof, and fuel cell systems using the membranes, are disclosed. Embodiments of the membrane include flexible proton electrolyte membranes that are proton conducting, thermally stable, mechanically strong, and mechanically flexible. In addition, the flexible proton electrolyte membranes are adapted to operate under low relative humidity (e.g., 0% to 25% relative humidity) or high relative humidity (e.g., up to 100% relative humidity), thereby eliminating the need for a humidity management system, although one can be used, to monitor the humidity of the fuel cell. The flexible proton electrolyte membranes are sufficiently conductive at a low relative humidity to be useful in fuel cell systems. As a result, fuel cell systems including the flexible proton electrolyte membranes can be operated at higher temperatures (e.g., above the vaporization point of water), which results in lower carbon monoxide poisoning. In addition, the fuel cell systems do not need, but can include, a thermal management system, which normally ensures the temperature does not exceed the vaporization point of water. Thus, fuel cells using flexible proton electrolyte membranes can be simplified by decreasing the components used in the fuel cell system (e.g., the humidity management system and/or the thermal management system).

As will be described in greater detail below, the flexible proton electrolyte membrane is conductive under low or no relative humidity, in part, because inorganic acids (e.g., —SO₃H and H₃PO₄) are incorporated into the chemical backbone of the flexible proton electrolyte membrane. The flexible proton electrolyte membrane can be used in electrochemical devices such as fuel cell systems, hydrogen separation, and gas sensors.

The flexible proton electrolyte membrane has a proton conductivity of about 1×10⁻⁶ to 1×10⁻¹ S/cm at a temperature range of about room temperature to about 180° C. and a relative humidity of about 0% to 100%. In particular, the flexible proton electrolyte membrane has a proton conductivity of about 1×10⁻⁴ to 1×10⁻¹ S/cm at a temperature range of about 90° C. to about 150° C. and a relative humidity of about 0% to 25%. One embodiment of the flexible proton electrolyte membrane has a proton conductivity of about 1×10⁻⁵ to 1×10⁻¹ S/cm at a temperature range of about 70° C. to about 120° C. and a relative humidity of about 0% to 25%. Exemplary samples are described in Tables 1A and 1B further below.

In addition, the flexible proton electrolyte membrane is thermally stable up to about 250° C., up to 200° C., and up to 180° C., as determined separately. The flexible proton electrolyte membrane is mechanically strong and mechanically flexible. For example, it does not tear or become deformed under normal operating conditions.

The flexible proton electrolyte membrane can have a thickness from about 0.1 micrometers to 0.5 millimeters and a radius of about 2 to 8 inches. In particular, the flexible proton electrolyte membrane can have a thickness from about 0.1 to 0.3 millimeters if the membrane is free standing. In the case where the flexible proton electrolyte membrane is supported on a structure (e.g., a porous carbon electrode), the thickness can be from about 20 micrometers to 100 micrometers. It should be noted that the radius of the flexible proton electrolyte membrane could vary, depending on the application that the flexible proton electrolyte membrane is to be used.

In general, the flexible proton electrolyte membrane has a chemical structure including a hybrid inorganic-organic copolymer network having a Si—O—Si backbone. The Si—O—Si backbone is crosslinked with organic polymer chains. Inorganic acid groups are attached to the Si through an organic chain. In addition, H₃PO₄ compounds are attached (as shown in Structures A1 through G below) to Si through oxygen in the hybrid inorganic-organic copolymer network. The H₃PO₄ compound is attached to the Si backbone through an oxygen bridge to avoid the leaching out of acid group from the membranes. Thus, the dependence of proton conductivity on humidity is decreased, while increasing the possibility of using the PEM at high operating temperatures, water resistance, and long-term stability of the PEM under practical operating conditions. Furthermore, a methyl or ethyl group is attach to Si. Methyl- or ethyl-alkoxysilyl termination will decrease the degree of crosslinking of the copolymer, leading to planar or linear polymers with flexibility, rather than fully cross-liked rigid structures. In general, the mechanical flexibility of these copolymers increases with the degree of this termination. Thus, the mechanical strength and flexibility of the copolymer can be tailored by the degree of CH₃—, C₂H₅— termination.

One embodiment of the flexible proton electrolyte membrane has a chemical structure including a hybrid inorganic-organic copolymer network having at least one backbone unit having a formula [—O—Si(WX)—O—Si(YZ)-R¹—]. Groups W, X, Y, and Z can include groups such as, but not limited to, —R²A, —R³, —O—, and —OPO₃H₂. Groups R¹, R², and R³ are hydrocarbons.

Group R¹ can include hydrocarbons such as, but not limited to, a linear C₂ to C₂₀ hydrocarbon, a branched C₂ to C₂₀ hydrocarbon, a halogen-substituted linear C₂ to C₂₀ hydrocarbon, and a halogen-substituted branched C₂ to C₂₀ hydrocarbon.

Group R² can include hydrocarbons, but not limited to, a linear C₂ to C₂₀ hydrocarbon, a branched C₂ to C₂₀ hydrocarbon, a hydrocarbon including an aromatic ring, a halogen-substituted linear C₂ to C₂₀ hydrocarbon, a halogen-substituted branched C₂ to C₂₀ hydrocarbon, and a halogen-substituted hydrocarbon including an aromatic ring.

Group R³ can include a hydrocarbon such as, but not limited to, CH₃ and C₂H₅.

Group A can include an inorganic acid group such as, but not limited to, SO₃H, —SO₂NHSO₂CF₃, —CF₂SO₃H, and —CF₂SO₂NHSO₂CF₃.

Exemplary structures are illustrated in Structures A1 through E, while Structures F and G includes two embodiments defining the A group.

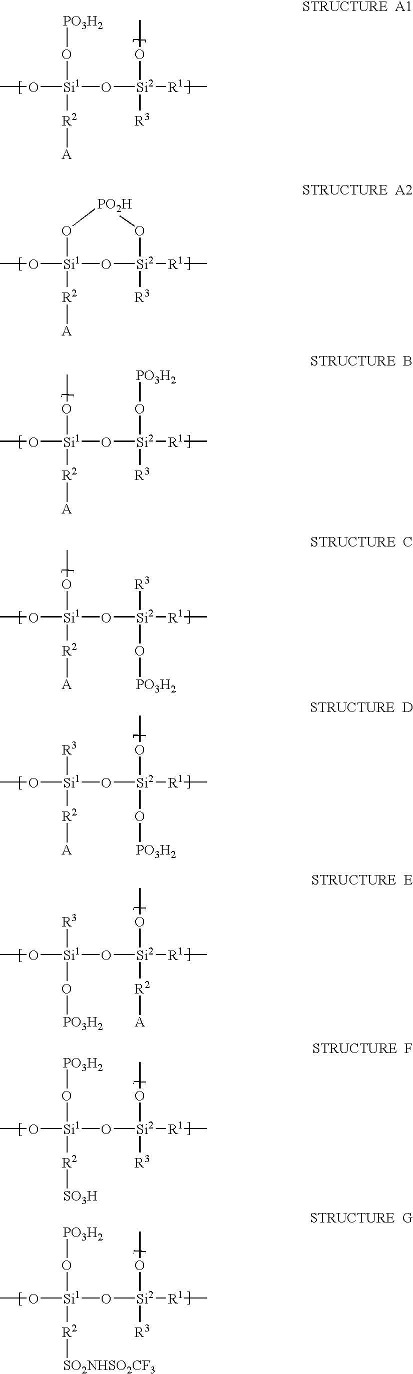

Another embodiment of the flexible proton electrolyte membrane has a chemical structure including a hybrid inorganic-organic copolymer network having at least one backbone unit having a formula [—O—Si(WX)—O—Si(YZ)-R¹—O—R⁴]. Groups W, X, Y, and Z can include, but are not limited to, —R²A, —R³, —O—, and —OPO₃H₂. Groups R¹, R², and R³ are similar to those described above. Group R⁴ is a hydrocarbon. In particular, group R⁴ is a hydrocarbon such as, but not limited to, a linear C₂ to C₂₀ hydrocarbon, a branched C₂ to C₂₀ hydrocarbon, a halogen-substituted linear C₂ to C₂₀ hydrocarbon, a halogen-substituted branched C₂ to C₂₀ hydrocarbon, as well as hydrocarbon chains including aromatic rings. An exemplary structure is shown in Structure H.

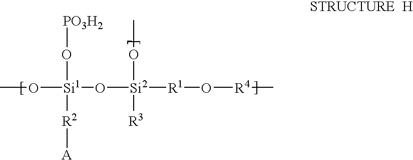

This embodiment of the flexible proton electrolyte membrane can be fabricated by mixing components to form a sol-gel and then treating (e.g., evaporating the sol-gel and/or heating the sol-gel) the sol-gel to form the flexible proton electrolyte membrane. The components include, but are not limited to, at least one hybrid inorganic-organic copolymer network former compound, a first compound including an inorganic acid functional group (A), a Si—O—Si inorganic backbone former compound, and a H₃PO₄ compound.

The hybrid inorganic-organic copolymer network former compound includes, but is not limited to, an epoxide ring containing alkoxysilane compound. The epoxide ring containing alkoxysilane compound can include, but is not limited to, an aliphatic epoxide ring containing alkoxysilane compound and a cycloaliphatic epoxide ring containing alkoxysilane compound.

In particular, the epoxide ring containing alkoxysilane compound can include, but is not limited to, (D₃₋ₓMₓ)SiR⁵C₂H₃O and (D₃₋ₓMₓ)SiR⁵C₆H₉O. The group D can include, but is not limited to, C₂H₅O and CH₃O. The group M can include, but is not limited to, C₂H₅ and CH₃. Subscript x is from 0 to 2. The group R⁵ can include hydrocarbons such as, but not limited to, a C₂ to C₂₀ hydrocarbon chain. The hydrocarbon can include, but is not limited to, linear hydrocarbons, halogen-substituted hydrocarbons, branched hydrocarbons, halogen-substituted branched hydrocarbons, as well as hydrocarbon chains including aromatic rings. In addition, the hydrocarbon can be saturated.

For example, the epoxide ring containing alkoxysilane compound can include, but is not limited to, (3-glycidoxypropyl)methyldiethoxysilane, (3-glycidoxypropyl)methyldimethoxysilane, (3-glycidoxypropyl)triethoxysilane, (3-glycidoxypropyl)trimethoxysilane, 5,6-epoxyhexyltriethoxysilane, 5,6-epoxyhexyltrimethoxysilane, 2-(3,4-epoxycyclohexyl)ethyltriethoxysilane, and 2-(3,4-epoxycyclohexyl)ethyltrimethoxysilane.

Another hybrid inorganic-organic copolymer network former can include, but is not limited to, an aliphatic diepoxide monomer and a cycloaliphatic diepoxide monomer. In particular, the hybrid inorganic-organic copolymer network former can include, but is not limited to, (C₂H₃O)R⁶(C₂H₃O) and C₆H₉OR⁶C₆H₉O. The group R⁶ can include hydrocarbons such as, but not limited to, a C₂ to C₂₀ hydrocarbon chain. The hydrocarbon can include, but is not limited to, linear hydrocarbons, halogen-substituted hydrocarbons, branched hydrocarbons, halogen-substituted branched hydrocarbons, as well as hydrocarbon chains including aromatic rings. In addition, the hydrocarbon can be saturated.

For example, the hybrid inorganic-organic copolymer network former can include, but is not limited to, 1,3-butadiene diepoxide, dicyclopentadiene diepoxide, and 3,4-epoxycyclohexylmethyl-3,4,-epoxy-cyclohexanecarboxylate.

The first compound including an inorganic acid functional group (A) can include, but is not limited to, (D₃₋ₓMₓ)SiR⁷A. The group D includes, but is not limited to, C₂H₅O and CH₃O. The group M includes, but is not limited to, C₂H₅ and CH₃. The subscript x is from 0 to about 2. The group R⁷ can include hydrocarbons such as, but not limited to, a C₂ to C₂₀ hydrocarbon chain. The hydrocarbon can include, but is not limited to, linear hydrocarbons, halogen-substituted hydrocarbons, branched hydrocarbons, halogen-substituted branched hydrocarbons, as well as hydrocarbon chains including aromatic rings. In addition, the hydrocarbon can be saturated. For example, the first compound including an inorganic acid functional group (A) can include, but is not limited to, sulfonated phenyltriethoxysilane (SPS), sulfonated phenylethyltriethoxysilane, and 3-(trihydroxysilyl)-11-propane sulfonic acid.

The Si—O—Si inorganic backbone former compound can include, but is not limited to, tetraethoxysilane (TEOS) and tetramethoxysilane (TMS). The H₃PO₄ compound can include, but is not limited to, H₃PO₄ and precursor compounds thereof such as salts.

The component mixture can be described as follows: the hybrid inorganic-organic copolymer network former compound is from about 20 to 80 mole ratio of the membrane, the first compound including an inorganic acid functional group (A) is from about 0 to 20 mole ratio of the membrane, the Si—O—Si inorganic backbone former compound is from about 20 to 80 mole ratio of the membrane, and the H₃PO₄ compound is about 0.5 to 1.5 times the total Si moles in the membrane. In particular, the hybrid inorganic-organic copolymer network former compound is from about 40 to 60 mole ratio, the first compound including an inorganic acid functional group (A) is from about 5 to 15 mole ratio of the membrane, the Si—O—Si inorganic backbone former compound is from about 40 to 60 mole ratio of the membrane, and the H₃PO₄ compound is about 0.5 to 1 times the total Si moles in the membrane.

Another embodiment of the flexible proton electrolyte membrane has a chemical structure including a hybrid inorganic-organic copolymer network having at least one backbone unit having a formula [—O—Si(WX)—O—Si(YQ)-R¹—Si(YQ)-]. Groups W, X, and Y can include, but are not limited to, —OPO₃H₂, —R²A, —R³. Group Q includes [—O—Si—R⁸—Si—]. Groups R² and R³ are hydrocarbons similar to those described above. However, in this instance groups R¹ as well as group R⁸ are either a short chain hydrocarbon or a long chain hydrocarbon. Groups R¹ and R⁸ are different (e.g., both R¹ and R⁸ are not short chain hydrocarbons). The short chain hydrocarbon includes hydrocarbons such as, but not limited to, a linear C₂ to C₂₀ hydrocarbon, a branched C₂ to C₂₀ hydrocarbon, a halogen-substituted linear C₂ to C₂₀ hydrocarbon, a halogen-substituted branched C₂ to C₂₀ hydrocarbon, as well as hydrocarbon chains including aromatic rings. The long chain hydrocarbon includes hydrocarbons such as, but not limited to, a hydrocarbon having a molecular weight from about 500 to 100,000 and a halogen-substituted hydrocarbon having a molecular weight from about 500 to 100,000. An exemplary structure is shown in Structures I through L.

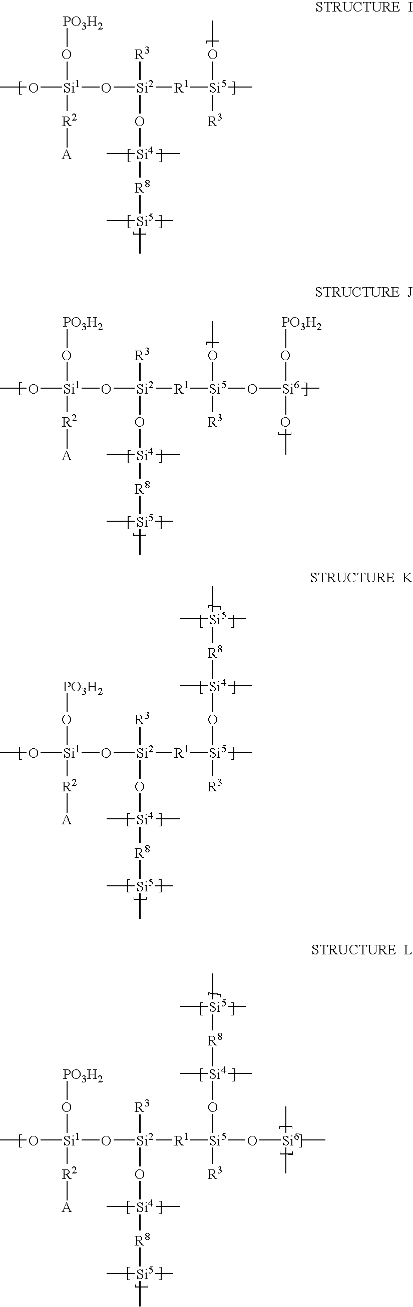

Some embodiments include heterocycles such as, but not limited to, imidazole-containing compounds and pyrozole compounds dispersed among the hybrid inorganic-organic copolymer network. This embodiment of the flexible proton electrolyte membrane can be fabricated by mixing components to form a sol-gel and then treating (e.g., evaporating the sol-gel and/or heating) the sol-gel to form the flexible proton electrolyte membrane. The components include, but are not limited to, a bis(alkylalkoxysilyl)-terminated polymer compound, a bis(trialkoxysilyl)-terminated short organic chain compound, the first compound including an inorganic acid functional group (A), a Si—O—Si inorganic backbone former compound, and a H₃PO₄ compound. In addition, the flexible proton electrolyte membrane can include a imidazole-ring containing compound such as, but not limited to, imidazole, benzimidazole, 2-phenyl imidazole (PI), 2-methyl 4-ethyl imidazole, and imidazole-2-carboxaldehyde.

The bis(alkylalkoxysilyl)-terminated polymer compound includes, but is not limited to, (D₃₋ₓMₓ)SiR⁹Si (D₃₋ₓMₓ). The group D can include, but is not limited to, C₂H₅O and CH₃O. The group M includes, but is not limited to, C₂H₅ and CH₃. The group R⁹ can include, but is not limited to, a linear hydrocarbon chain having a molecular weight from about 500 to 100,00 and from about 500 to 50,000. The subscript x is from 1 to 2.

For example, the bis(alkylalkoxysilyl)-terminated polymer compound can include, but is not limited to, bis((3-methyldimethoxysilyl)propyl) polypropylene oxide, bis((3-methyldimethoxysilyl)propyl)polytetraethlene oxide, bis(methyldimethoxysilyl)poly(1-butene), bis(methyldimethoxysilyl)polyethylene, bis(dimethylmethoxysilyl)polyethylene, bis(methyldimethoxysilyl)polyvinylidene fluoride, bis(methyldimethoxysilyl)polystyrene, bis(methyldimethoxysilyl)polytetrafluoroethylene, bis(methyldimethoxysilyl)polyvinylchloride, bis(methyldimethoxysilyl)polyvinylalcohol, and bis(methyldimethoxysilyl)polypropylene.

The bis(trialkoxysilyl)-terminated short organic chain compound can include, but is not limited to, (D₃)SiR¹⁰Si (D₃). The group D includes, but is not limited to, C₂H₅O and CH₃O. The group R¹⁰ can include hydrocarbons such as, but not limited to, a C₂ to C₂₀ hydrocarbon chain. The hydrocarbon can include, but is not limited to, linear hydrocarbons, halogen-substituted hydrocarbons, branched hydrocarbons, halogen-substituted branched hydrocarbons, as well as hydrocarbon chains including aromatic rings.

For example, the bis(alkylalkoxysilyl)-terminated polymer compound can include, but is not limited to, bis(triethoxysilyl)ethane, bis(triethoxysilyl)octane, bis(triethoxysilyl)nonane, bis(triethoxysilyl)methane, bis(triethoxysilylethyl)benzene, bis(triethoxysilyl)hexane, bis(trimethoxysilylpropyl)amine, bis[(trimethoxysilyl)propyl)]ethylenediamine, bis(trimethoxysilyl)ethane, bis(trimethoxysilyl)octane, bis(trimethoxysilyl)nonane, bis(trimethoxysilyl)methane, bis(trimethoxysilylethyl)benzene, and bis(trimethoxysilyl)hexane.

The first compound including an inorganic acid functional group (A) can include, but is not limited to, (D₃₋ₓMₓ)SiR¹¹A. The group D includes, but is not limited to, C₂H₅O and CH₃O. The group M includes, but is not limited to, C₂H₅ and CH₃. The subscript x is from 0 to 2. The group R¹¹ can include hydrocarbons such as, but not limited to, a C₂ to C₂₀ hydrocarbon chain. The hydrocarbon can include, but is not limited to, linear hydrocarbons, halogen-substituted hydrocarbons, branched hydrocarbons, halogen-substituted branched hydrocarbons, as well as hydrocarbon chains including aromatic rings. For example, the first compound including an inorganic acid functional group (A) can include, but is not limited to, sulfonated phenyltriethoxysilane (SPS), sulfonated phenylethyltriethoxysilane, and 3-(trihydroxysilyl)-1-propane sulfonic acid.

The Si—O—Si inorganic backbone former compound can include, but is not limited to, tetraethoxysilane and tetramethoxysilane. The H₃PO₄ compound can include, but is not limited to, H₃PO₄ and precursor compounds thereof, such as salts.

The component mixture can be described as follows: about 1 to 2 moles of Si derived from the bis(alkylalkoxysilyl)-terminated polymer compound, about 0 to 3 moles of Si derived from the bis(trialkoxysilyl)-terminated short organic chain compound, about 0 to 3 moles of Si derived from the first compound including an inorganic acid functional group (A), about 0 to 2 moles of Si derived from the Si—O—Si inorganic backbone former compound, and wherein about 10-150% of the moles of Si from the bis(alkylalkoxysilyl)-terminated polymer compound, bis(trialkoxysilyl)-terminated short organic chain compound, the first compound including an inorganic acid functional group (A), the Si—O—Si inorganic backbone former compound, equals the moles of H₃PO₄. In particular, the component mixture can be described as follows: about 1 to 1.5 moles of Si derived from the bis(alkylalkoxysilyl)-terminated polymer compound, about 1 to 2 moles of Si derived from the bis(trialkoxysilyl)-terminated short organic chain compound, about 1 to 2 moles of Si derived from the first compound including an inorganic acid functional group (A), about 1 to 2 moles of Si derived from the Si—O—Si inorganic backbone former compound, and wherein about 50% to 100% of the moles of Si from the bis(alkylalkoxysilyl)-terminated polymer compound, bis(trialkoxysilyl)-terminated short organic chain compound, the first compound including an inorganic acid functional group (A), the Si—O—Si inorganic backbone former compound, equals the moles of H₃PO₄.

Now having described the flexible proton electrolyte membranes in general, Tables 1A and 1B illustrate the components and some characteristics often exemplary flexible proton electrolyte membranes. These examples are not intended to limit the scope of any embodiment of this disclosure, but rather are intended to provide specific exemplary embodiments. Therefore, one skilled in the art would understand that the components, the ratios of the components used, and conditions in which the membranes were tested can be modified, and it is intended that these modifications be within the scope of the embodiments of this disclosure.

TABLE 1A
(in moles)

| | GPTS¹ | TEOS² | SPS³ | MDSPPO⁴ | BTESO⁵ | H₃PO₄⁶ | PI⁶ |
|---|---|---|---|---|---|---|---|
| Sample | 0.23 | 0.77 | 0 | 0 | 0 | 0.77 | 0 |
| 1 | | | | | | | |
| Sample | 0.5 | 0.5 | 0 | 0 | 0 | 1.0 | 0 |
| 2 | | | | | | | |
| Sample | 0.5 | 0.5 | 0 | 0 | 0 | 0.5 | 0 |
| 3 | | | | | | | |
| Sample | 0.4 | 0.5 | 0.09 | 0 | 0 | 0.5 | 0 |
| 4 | | | | | | | |
| Sample | 0.4 | 0.6 | 0 | 0 | 0 | 0.8 | 0 |
| 5 | | | | | | | |
| Sample | 0 | 3 | 1 | 2 | 0 | 5 | 0 |
| 6 | | | | | | | |
| Sample | 0 | 3 | 1 | 1 | 0 | 5 | 0 |
| 7 | | | | | | | |
| Sample | 0 | 3 | 0 | 2 | 0 | 5 | 0.1 |
| 8 | | | | | | | |
| Sample | 0 | 1 | 0 | 2 | 2 | 5 | 0 |
| 9 | | | | | | | |
| Sample | 0 | 1 | 0 | 2 | 2 | 3 | 0 |
| 10 | | | | | | | |

¹3-glycidoxypropyltrimethoxysilane (GPTS),
²Tetraethoxysilane (TEOS)
³Sulfonated phenyltriethoxysilane (SPS),
⁴Bis(3-methyldimethoxysilyl)polypropylene oxide (MDSPPO), ⁵ Bis(triethoxysilyl)octane (BTESO), and
⁶2-phenyl imidazole (PI).

TABLE 1B

| | Proton conductivity | |
|---|---|---|
| | (RH = relative humidity) | Other Characteristics |
| Sample 1 | 0.33 × 10⁻² S/cm, 120° C., 1% RH | Stable up to 250° C. in dry air, |
| | | Flexible. |
| Sample 2 | 1.1 × 10⁻² S/cm, 100° C., 22% RH | Stable up to 250° C. in dry air, |
| | | Flexible |
| Sample 3 | 6.5 × 10⁻⁵ S/cm, 120° C., anhydrous | Stable up to 250° C. in dry air, |
| | state | Flexible |
| Sample 4 | 1.0 × 10⁻² S/cm, 120° C., 15% RH | Stable up to 180° C. in dry air, |
| | | Flexible |
| Sample 5 | 2.4 × 10⁻⁴ S/cm, 100° C., anhydrous | Stable up to 250° C. in dry air, |
| | state | Flexible |
| Sample 6 | 2.3 × 10⁻⁴ S/cm, 100° C., anhydrous | Stable up to 180° C. in dry air, |
| | state | Plastic-like |
| Sample 7 | 6.2 × 10⁻⁴ S/cm, 70° C., anhydrous state | Stable up to 180° C. in dry air, |
| | | Plastic-like |
| Sample 8 | 0.37 × 10⁻² S/cm, 140° C., anhydrous | Stable up to 180° C. in dry air, |
| | state | Plastic-like |
| Sample 9 | 4.6 × 10⁻² S/cm, 100° C., 22% RH | Stable up to 200° C. in dry air, |
| | | Plastic-like |
| Sample 10 | 1.6 × 10⁻² S/cm, 100° C., 22% RH | Stable up to 200° C. in dry air, |
| | | Plastic-like |

Prior to forming the flexible proton electrolyte membrane, the components are mixed to form a sol-gel. In general, the components (1) at least one hybrid inorganic-organic copolymer network former compound, the first compound including an inorganic acid functional group (A), and the Si—O—Si inorganic backbone former compound, and (II) the bis(alkylalkoxysilyl)-terminated polymer compound, the bis(trialkoxysilyl)-terminated short organic chain compound, the first compound including an inorganic acid functional group (A), and the Si—O—Si inorganic backbone former compound) are mixed with an alcohol (e.g., ethanol) and mixed for about 20 minutes. Next, an acidic solution (e.g., aqueous HCl) is added dropwise to the mixture until a pH of about 1 to 5 is achieved and mixed for about 30 minutes. Subsequently, an H₃PO₄ compound is added dropwise to the mixture and mixed for at least approximately 12 hours to form the sol-gel. The amount of water (aqueous HCl) added to the mixture is about four times the total Si moles. The ratios of the components correspond to the ratios described above. In one embodiment, the heterocycle compound can be added at any point during the process.

After the sol-gel is formed, the flexible proton electrolyte membrane can be formed through evaporations and heating procedures over the course of a few days to a few weeks. In general, a sol-gel mixture is provided. As mentioned above, the sol-gel mixture can be include group 1 or group 2. Group 1 includes, but is not limited to, at least one hybrid inorganic-organic copolymer network former compound, the first compound including an inorganic acid functional group (A), the Si—O—Si inorganic backbone former compound, and the H₃PO₄ compound. Group 2 includes, but is not limited to, the bis(alkylalkoxysilyl)-terminated polymer compound, the bis(trialkoxysilyl)-terminated short organic chain compound, the first compound including an inorganic acid functional group (A), the Si—O—Si inorganic backbone former compound, and the H₃PO₄ compound. Next, the sol-gel is disposed on a substrate such as, but not limited to, a petri dish, glass container, plastic container, metal container, carbon board, and the like. Subsequently, the sol-gel is heated to form the flexible proton exchange membrane having the characteristic as described above.

For example, the sol-gel can be disposed in a petri dish and covered with a cover. The sol-gel is heated at about 40 to 60° C. in a dry oven for about 2 to 5 days. Subsequently, a hole or opening is provided in the cover to allow the solvent to evaporate for 3 to 10 days at about 40 to 65° C. Next, the cover is removed and the sol-gel is heated to about 50 to 70° C. in a dry oven for about 2 to 5 days; heated to about 70 to 90° C. in a dry oven for about 6 to 24 hours; and heated to about 90 to 110° C. in a dry oven for about 2 to 10 hours. After the last heating cycle, the flexible proton electrolyte membrane can be removed from the petri dish and used in a selected application.

In another example, the sol-gel can be disposed on a first carbon board and a second carbon board. The sol-gel is allowed to settle on the carbon boards for about 2 to 6 hours in air. Next, the first carbon board is disposed on the second carbon board for about 1 to 3 days in air, forming a structure. Subsequently, the structure is heated to about room temperature to 60° C. in a dry oven for about 10 to 18 hours; heated to about 60 to 80° C. in a dry oven for about 6 to 12 hours; and heated to about 80 to 120° C. in a dry oven for about 1 to 2 hours. The structure is heated at a rate of about 0.2 to 1C per minute.

Now having described the membranes, methods of use thereof, methods of making thereof, and fuel cell systems using the membranes in general, the following describes exemplar embodiments of the membranes. These examples are not intended to limit the scope of any embodiment of this disclosure, but rather is intended to provide specific exemplary embodiments. Therefore, one skilled in the art would understand that many conditions can be modified to produce a desired result, and it is intended that these modifications be within the scope of the embodiments of this disclosure.

Example 1 is discussed in the paper entitled “Synthesis and Conductivity of Proton-Electrolyte Membranes Based on Hybrid Organic-Inorganic Copolymers,” S. Li and M. Liu, Electrochimica Acta, 48(28), 4271-4276 (2003), which is incorporated herein by reference. Example 2 is discussed in the paper entitled “New Proton Electrolyte Membranes based on Hybrid Inorganic-Organic Polymers,” (submitted to J. Electrochemical Soc.), which is incorporated herein by reference.

### EXAMPLE 1

In Example 1, a series of such hybrid inorganic-organic membranes doped with H₃PO₄ were prepared from GPTS, sulfonated phenyltriethoxysilane (SPS), and TEOS. The proton conductivity is about 10⁻³ S/cm above 100° C. in a dry atmosphere, and reaches 10⁻² S/cm in an atmosphere with RH of about 20%. In addition, a process for fabrication membranes as thin as 20 microns on porous electrodes has also been developed.

### EXPERIMENTAL

Preparation of the sols: SPS was synthesized by reaction of phenyltriethoxysilane (Aldrich, 98%) and chlorosulfonic acid (Alfa, 99%). The precursor solution was prepared by mixing GPTS (Alfa, 96%), TEOS (Aldrich, 98%), and SPS with ethanol. After stirring for 20 minutes, 0.5 N HCl aqueous solution was added dropwise to the precursor solution, and stirred for 30 minutes. After H₃PO₄ was added dropwise, the solution was stirred for at least 12 hours to form sols. The amount of water added is 4 times of the total Si in moles. The samples were labeled by their mole composition as (100-x-y) SPS-x TEOS-y GPTS-z H₃PO₄, where z is the ratio of H₃PO₄ to total Si, x varied from 100 to 40, y from 0 to 50, and z from 50 to 100.

Preparation of self-standing membranes: To make self-standing membranes, the sol was cast onto petri dishes. After the petri dish was covered and kept in a dry oven at 60° C. for 3 days, a small hole was opened on the cover to allow the evaporation of the organic solution and water slowly in about 6 days. Then the covers were removed and the membranes were dried at 60° C. for another 3 days, at 80° C. for 12 hours, and at 100° C. for 3 hours.

Preparation of membranes sandwiched between carbon electrodes: The hybrid membranes sandwiched between porous carbon boards were prepared as follows: the porous carbon board was held vertically to let the sol dropped on the top to flow down naturally; when the sol reached the bottom of the board, the sample was flipped vertically and the sol flowed down again. The liquid-film-covered carbon board was left in air for 1 or 2 hours until the film gelled. Then two film-covered carbon boards were put together face to face, pressed by a glass slide, and then left in air for 2 days. Subsequently, the sandwich was dried in an oven (with a heating rate of 0.5° C. per minute) at 60° C. for 12 hours, at 80° C. for 6 hours, and at 120° C. for 1 hour.

Characterization: X-ray diffraction patterns of the gels were obtained on a Philips PW 1800 diffractometer with Cu K_{α} radiation. The morphologies and element composition were characterized with a scanning electron microscope (SEM, Hitachi S-800). Thermogravimetric analysis (TGA) and differential scanning calorimetry (DSC) were performed on a Rheometric Scientific STA 1500 in dry air. ³¹P MAS-NMR spectra were acquired using a Bruker DSX 400 spectrometer operating at 161.86 MHz. The ³¹P signal from NH₄H₂PO₄ at 298 K was referenced to 6=0 ppm. The small pieces of membranes with about 0.5 mm thickness and 0.6 cm² area were used to measure the proton conductivity using a SI 1255 frequency response analyzer and SI 1286 potentiostate/galvanostate in the frequency range of 0.01 Hz to 5 MHz. Two silver pellets were used as the electrodes. The measurements were run in a small dry oven with flowing N₂ gas. To measure the proton conductivities of the membranes in anhydrous sate, all membranes were dried in dry N₂ gas at 80° C. for 3 hours and at 100° C. for 6 hours, or at 100° C. for 1 hour and at 120° C. for 3 hours, to remove water in the membranes before measurements. Saturated MgCl₂ aqueous solution in a closed chamber was used to control the RH at 22.5% (100° C.) and 15% (120° C.).

Results and Discussion

Appearance of the membranes and films: All as-prepared self-standing membranes are transparent, and the mechanical flexibility generally increases with the GPTS contents. The membranes of 15 cm² with different thickness can be readily prepared by casting on plastic or glass petri dishes. The samples without SPS remained colorless after being kept at 100° C. for 3 hours when the content of H₃PO₄ is less than 80. The samples with 20 SPS-57 TEOS-23 GPTS-77H₃PO₄ turned to brown when kept at 100° C. for 3 hours in a dry atmosphere. Such color change may be attributed to the fact that the —SO₃H groups may react with the —OH groups to form —S—O—C bridges and water at high temperatures. With increasing GPTS contents, the membranes become more difficult to separate from the petri dishes during casting of PEM due to the increasing adhesion of the membranes to glass and plastics. Meanwhile, the shrinkage of the membranes in the drying process decreases with increasing GPTS contents. There is even no observable shrinkage in the sample with 50 GPTS. Such hybrid inorganic-organic copolymer materials are easy to be made into thin membranes supported by porous carbon electrode boards. It is noted that no deliquesce was observed on the surface of the membranes with GPTS content larger than 30 after they were left in ambient air at room temperature for several days, or kept in an environment with RH 20% above 100° C. for several hours. The stability of H₃PO₄ in the new membranes should be attributed to the high affinity of Si—O based hybrid inorganic-organic network to H₃PO₄ molecules.

Microstructure of the membranes: Shown in FIG. 2 is an SEM picture of the fractured surface of a membrane with composition of 0 SPS-50 TEOS-50 GPTS-50H₃PO₄, supported by porous carbon-electrode boards. It is about 20-μm thick and 5 cm² in area without cracks. Higher magnification SEM views of the fractured surface of two hybrid inorganic-organic membranes indicate that both samples are dense, and the sample with 50 GPTS has a smoother surface than that with 23 GPTS.

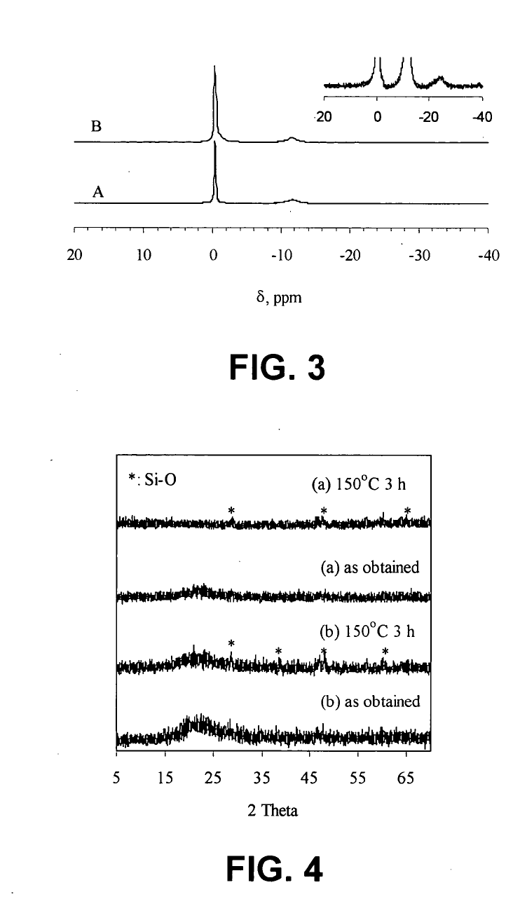

Status of phosphoric acid in the membranes: The status of phosphorous acid in the hybrid inorganic-organic membranes was studied using ³¹P MAS-NMR. Shown in FIG. 3 are the NMR spectra of two samples, 0 SPS-77 TEOS-23 GPTS-77H₃PO₄ and 0 SPS-50 TEOS-50 GPTS-100H₃PO₄. Three ³¹P resonance peaks were observed; one of which is too weak to be visible in the full spectra. The extremely strong peak at δ≈−0.5 ppm is attributed to the undissociated H₃PO₄ and other dissociated species such as H₄PO₄⁺ and H₂PO₄⁻. The latter two species are known to be within 2 ppm of the undissociated H₃PO₄ signal. The other two weak peaks at δ≈−11.5 ppm and δ≈−23.5 ppm are due to the end and middle units of pyrophosphoric acid and tripolyphosphoric acid. It should be mentioned that the weak peak at δ≈−11.5 ppm may be assigned to the phosphates bound to one silicon atom through P—O—Si bonds, which means that part of H₃PO₄ was attached to the Si—O—Si network in the hybrid inorganic-organic copolymer. However, the integral of the two weak peaks is only about 20% of the total ³¹P resonance peaks, implying that about 80% of phosphoric acid exists in the free form, including undissociated H₃PO₄ and dissociated species such as H₄PO₄+ and H₂PO₄₋.

Phase analysis: The structures of the (at 100° C. for 6 hours) hybrid inorganic-organic membranes with 50 GPTS and those further dried at 150° C. for 3 hours were studied by XRD, shown in FIG. 4. Both membranes are amorphous, but with a weak broad peak near 2 theta=220, which may be assigned to the partial crystallization of the polymers formed among GPTS. After the membranes were kept at 150° C. for 3 hours, several weak peaks appeared which can be assigned to the Si—O oxide (see JCPDS card 03-1092). No peaks of Si—P—O compounds (such as Si₅P₆O₂₅ and SiP₂O₇) were observable in the spectrum. Thus, no crystallization between Si—O and H₃PO₄ took place in the heating process below 150° C. as observed in the SiO—H₃PO₄ gels.

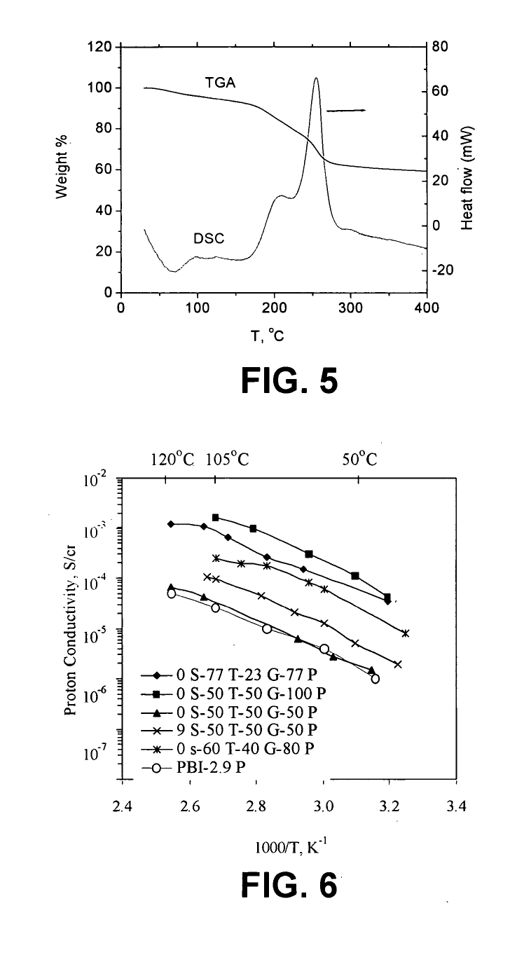

Thermal stability: Shown in FIG. 5 are the DSC/TGA curves of the sample with composition of 9 SPS-50 TEOS-50 GPTS-50H₃PO₄ in dry air from room temperature to 400° C. There are mainly three mass-loss steps in the TGA curve. The small weight loss from room temperature to 180° C. corresponds to the evaporation of the water and the small organic molecules in the membrane. The quick weight loss started near 180° C. may be attributed to the condensation of phosphoric acid doped in the membranes to form polyphosphoric acid and the decomposition of —SO₃H groups. The decomposition of the organic part of the copolymers starts at 250° C. Correspondingly, there appears an exothermic peak at 260° C. in the DSC curve. In addition, there is an unknown exothermic peak at 220° C. The hybrid inorganic-organic membranes are therefore stable up to 180° C. in dry air.

Proton conductivity: Shown in FIG. 6 are the proton conductivities of anhydrous membranes as measured in dry N₂ atmosphere using impedance spectroscopy. In general, proton conductivity increased with H₃PO₄ content, reaching 1.6×10⁻³ S/cm at 100° C. for a sample with composition of 0 SPS-50 TEOS-50 GPTS-100H₃PO₄, which is 40 times higher than that of the sample with composition of 0 SPS-50 TEOS-50 GPTS-50H₃PO₄. These results confirmed that the proton conduction in the hybrid membranes originates primarily from the dissociation among the H₃PO₄ molecules doped in the membranes. Comparing the proton conductivity of sample 0 SPS-77 TEOS-23 GPTS-77H₃PO₄ with that of 0 SPS-60 TEOS-40 GPTS-80H₃PO₄, it was found that that the proton conductivity decreases with increasing GPTS content. This can be explained by the fact that the H₃PO₄ concentration decreases with increasing GPTS content. It is reported that PBI-6H₃PO₄ has a proton conductivity of 2×10⁻³ S/cm at 100° C. in anhydrous state. However, PBI with high content of H₃PO₄ has a problem of H₃PO₄ leaching out. In fact, it has been reported that the upper limit of H₃PO₄ content in PBI is 2.9 moles. The proton conductivity of PBI-2.9H₃PO₄ under dry conditions at 100° C. is about 3×10⁻⁵ S/cm, as shown in FIG. 6 for comparison. Thus, the disclosed hybrid inorganic-organic membranes have much higher proton conductivity than PBI-H₃PO₄ membranes under similar conditions. The proton conductivity of the sample with composition of 9 SPS-50 TEOS-50 GPTS-50H₃PO₄ with —SO₃H groups is twice of that of the sample 0 SPS-50 TEOS-50 GPTS-50H₃PO₄. This can be attributed to the fact that the —SO₃H groups interact with H₃PO₄ in the membranes and create more H⁺defects as follows,

—SO₃H+H₃PO₄═—SO₃⁻+H₄PO₄⁺

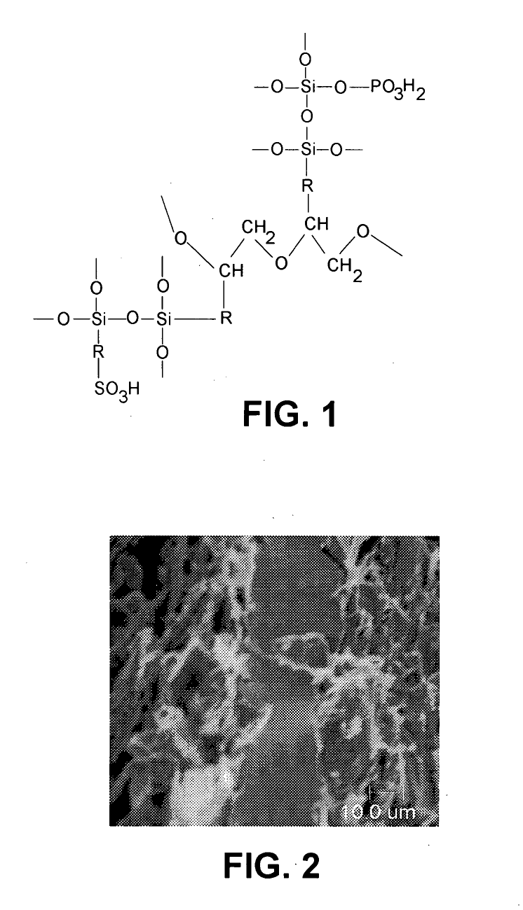

The addition of H₂SO₄ in pure H₃PO₄ has been reported to reduce the proton conductivity because it increased the viscosity, and thus decreased the proton mobility. In the new membranes, H₃PO₄ was dispersed among the hybrid inorganic-organic copolymer framework as shown in FIG. 1, and the viscosity change of the membranes caused by the addition of —SO₃H groups may be small. However, further investigation on the interaction of —SO₃H groups with H₃PO₄ and the framework of the hybrid inorganic-organic membranes is useful to understand the proton transportation mechanism and to further improve the proton conductivity. It is notable that the Log σ versus T⁻¹ curves are non-linear, indicating that the proton conduction in these samples does not obey Arrhenius law, but shows the character of the Vogel-Tamman-Fucher (VTF) behavior, indicating that segmental motion plays a role in the proton conductivity. The proton transportation in H₃PO₄ system follows Grotthuss mechanism. The curvature of proton conductivity dependence on temperature of the hybrid inorganic-organic membranes may reflect the interaction of H₃PO₄ species and the flexible PEO chains formed among GPTS.

To check the humidity dependence of the hybrid inorganic-organic membranes, the proton conductivities of the membranes were measured at 100° C. and 120° C. in N₂ gas through a water bubbler at 25° C. and in a closed chamber with saturated MgCl₂ aqueous solution. The proton conductivities of several samples are listed in Table 2. The calculated relative humidity of N₂ through the water bubbler is 1.7% at 100° C. and 1.0% at 120° C., and those in the closed chamber with saturated MgCl₂ aqueous solution is about 22.5% at 100° C. and 15% at 120° C. The samples were kept at 100° C. and 120° C. for several hours before conductivity measured until the measured values were stable. As expected, the proton conductivity increased dramatically with humidity. For example, the proton conductivity at 120° C. of a sample with composition of 9 SPS-50 TEOS-41 GPTS-50H₃PO₄ increased from 6.6×10⁻⁵ S/cm in dry N₂ to 4.2×10⁻⁴ S/cm in RH 1.0%, and to 0.99×10⁻² S/cm in RH 15%. The proton conductivity of sample with a composition of 0 SPS-50 TEOS-50 GPTS-100H₃PO₄ at 120° C. increased from 3.7×10⁻³ S/cm in RH 1.0% to 3.6×10⁻² S/cm in RH 15%. The increase in proton conductivity in wet atmosphere can be attributed to the fast transport of H₃O+as a vehicle of protons.

TABLE 2
Proton conductivities (S/cm) of 3 new membranes under the
conditions with different relative humidity

| | 100° C. | | 120° C. | |
|---|---|---|---|---|
| Samples | 1.7% RH | 22.5% RH | 1% RH | 15% RH |
| 0 SPS-77 TEOS-23 | 1.9 × 10⁻³ | — | 3.3 × 10⁻³ | — |
| GPTS-50 P | | | | |
| 9 SPS-50 TEOS-41 | 2.7 × 10⁻⁴ | 0.5 × 10⁻² | 4.2 × 10⁻⁴ | 1.0 × 10⁻² |
| GPTS-50 P | | | | |
| 0 SPS-50 TEOS-50 | 1.9 × 10⁻³ | 1.1 × 10⁻² | 3.7 × 10⁻³ | 3.6 × 10⁻² |
| GPTS-100 P | | | | |

### CONCLUSION

The hybrid inorganic-organic membranes based on GPTS, TEOS, and H₃PO₄ have good mechanical properties, dense structure, and high thermal stability. The proton conductivities are over 10⁻² S/cm under conditions with low relative humidity (<20%) above 100° C., representing the highest proton conductivity under similar conditions among the proton conducting materials ever reported, including PB₁—H₃PO₄. Further, these membranes can be easily made into membranes as thin as 20 μm on porous carbon boards, thus having great potential for application in high temperature PEM fuel cells and in DMFCs. Further improvement of the proton conductivity is possible by incorporating more —SO₃H groups into the copolymers.

### EXAMPLE 2

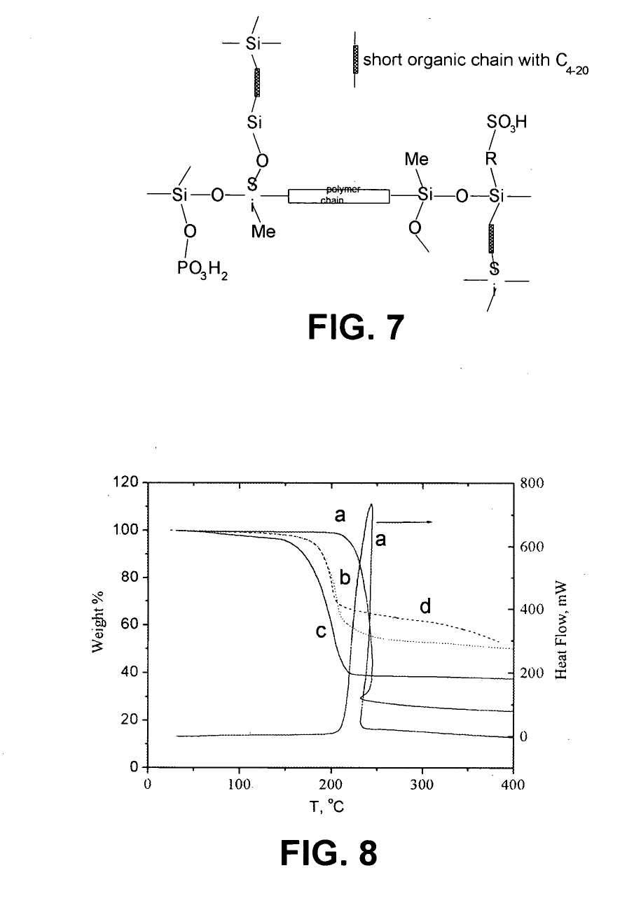

In Example 2, a new class of hybrid inorganic-organic copolymer membranes synthesized from bis(3-methyldimethyoxysilyl)polypropylene oxide (MDSPPO, see Scheme 1A), bis(triethoxysilyl)octane (BTESO, see Scheme 1B), tetraethyoxysilane (TEOS), 2-phenyl imidazole (PI), sulfonated phenyltriethoxysilane (SPTES), and H₃PO₄ is reported. Because MDSPPO has a long polypropylene (PPO) chain ending with methyldimethoxysilyl groups, the formed two-dimensional hybrid inorganic-organic copolymer network is highly flexible. BTESO was used as a cross-linker to improve the mechanical strength. An example of a structure shown in FIG. 7. These membranes are mechanically flexible, thermally stable up to 200° C., and highly conductive to protons in a dry atmosphere and in low relative humidity.

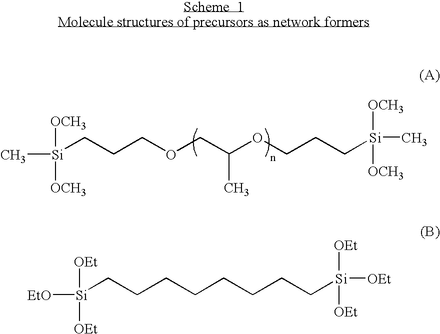

### EXPERIMENTAL

Exemplary electrolyte membranes were synthesized using a sol-gel process. The precursor solution was prepared by mixing MDSPPO (MW 600-900), BTESO (97%), TEOS (Aldrich, 98%), and SPTES with ethanol. SPTES was synthesized by reaction of phenyltriethoxysilane (Aldrich, 98%) and chlorosulfonic acid (Alfa, 99%) as described elsewhere. After stirring for 20 minutes, 0.5 N HCl aqueous solution was added dropwise to the precursor solution, and further stirred for another 30 minutes. H₃PO₄ was then added dropwise to the solution followed by stirring for 12 hours to form a sol. In one of the sols, 2-phenyl imidazole (PI, Alfa, 98%) solution of ethanol was added dropwise and stirred for several hours. The amount of water added is 4 times of the total amount of Si in moles. The samples were labeled by their mole composition as x S-y M-z Oc-m T-n P, where x, y, z, and m refer to the moles of Si in SPTES, MDSPPO, BTESO, and TEOS, respectively, and n refers to the moles of H₃PO₄. The sol was cast in petri dishes to form membranes, which were dried at 60° C. for several days, at 80° C. for 3 hours, and then at 100° C. for 1 hour to evaporate the organic solvents and water.

X-ray diffraction (XRD) patterns of the gels were obtained using a Philips PW 1800 diffractometer with Cu K_{α} radiation. The morphologies and microstructures were characterized using a scanning electron microscope (SEM, Hitachi S-800). Thermogravimetric analysis (TGA) and differential scanning calorimetry (DSC) of the samples in dry air were performed using a Rheometric Scientific STA 1500. The status of phosphorous acid in the hybrid inorganic-organic membranes was studied by ³¹P MAS-NMR using a Bruker DSX 400 spectrometer operating at 161.86 MHz. The ³¹P signal from NH₄H₂PO₄ at 298 K was referenced to 6=0 ppm. The proton conductivities of the membranes were determined by impedance spectroscopy using a SI 1255 frequency response analyzer and a SI 1286 potentiostate/galvanostate in the frequency range of 0.01 Hz to 5 MHz. Two silver pellets were used as the electrodes. The measurements were run in a small dry oven.

Results and Discussion

All prepared exemplary membranes are highly flexible like plastic and can be made as thin as 0.1 mm with good mechanical strength. The disclosed membranes can be readily prepared in large size, depending on the size of the molds. A piece of membrane in more than 170 cm² was obtained using a glass dish as mold. The membranes without PI are transparent. XRD analysis shows that they are almost amorphous with only a broad weak peak at 2 theta 23°, attributed to the partial crystallization of the organic polymers. The membranes with 2-phenyl imidazole (the mole ratio of PI/H₃PO₄ is 1/10) are white and opaque. XRD of the membranes confirmed that PI forms salt with H₃PO₄. SEM examinations show that the representative membranes are relatively dense. It is noted that no deliquescence was observed on the surface of all membranes after they were left in ambient air at room temperature for several days, or kept in an environment with RH 20% above 100° C. for several hours. The good stability of H₃PO₄ in these membranes is attributed to the high affinity of Si—O based hybrid inorganic-organic network to H₃PO₄ molecules.

Shown in FIG. 8 are several typical TGA and DSC curves for three samples from room temperature to 400° C. in dry air at a heating rate of 3° C./minute. The membrane without H₃PO₄ started to lose weight at 235° C. and an exothermic peak appeared at 250° C. in the DSC curve, indicating that the membrane is stable up to 230° C. The addition of H₃PO₄ reduced the thermal stability of membranes. A large weight % loss started at 170° C. for the membrane with a composition of 2 M-3 T-5 P, due probably to the condensation of phosphoric acid to form poly-phosphoric acid and the decomposition of the polymer network. The sample with BTESO as a cross-linker has much better thermal stability. It started to lose weight % quickly at near 200° C. Basic 2-phenyl imidazole improved the thermal stability of the membranes by reducing the acidity; the membranes with H₃PO₄ and 10% PI are stable up to 200° C.

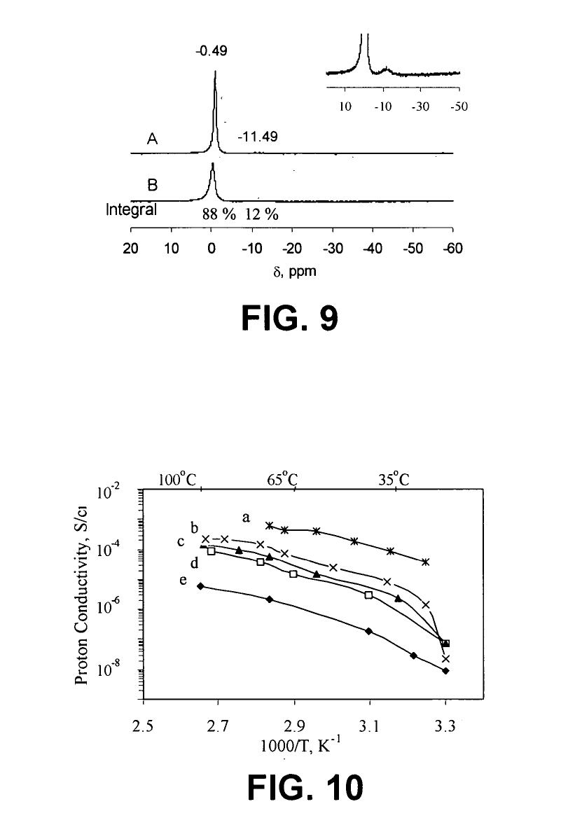

Shown in FIG. 9 are the NMR spectra of two samples with composition of 2 M-3 T-1 S-3 P and 2 M-3 T-5 P. Two ³¹P resonance peaks were observed; one of which is too weak to be visible in the full spectrum. The main peak at δ≈−0.5 ppm is attributed to the undissociated H₃PO₄ and other dissociated species such as H₄PO₄⁺ and H₂PO₄₋. The latter two species are known to be within 2 ppm of the undissociated H₃PO₄ signal. The second peak at δ≈−11.5 ppm is due to the end unit of pyrophosphoric acid. It should be mentioned that the weak peak at δ≈−11.5 ppm may be assigned to the phosphates bound to one silicon atom through P—O—Si bonds, which means that H₃PO₄ was attached to the Si—O—Si network in the hybrid inorganic-organic copolymer. However, the integral of the weak peak is only about 12% and 4% of the total ³¹P resonance peaks for the membranes with composition of 2 M-3 T-5 P and 2 M-3 T-1 S-3 P, respectively. This suggests that most of the phosphoric acid is present in the free form, including undissociated H₃PO₄ and dissociated species such as H₄PO₄⁺ and H₂PO₄₋.

Shown in FIG. 10 are the proton conductivities of the membranes as measured in dry N₂ gas. All membranes were dried in dry N₂ gas at 80° C. for 3 hours and at 100° C. for 6 hours to remove water in the membranes before conductivity measurements. The proton conductivity increased with the content of H₃PO₄. A proton conductivity measured at 100° C. was 2.4×10⁻⁴ S/cm for the membrane of 2 M-3 T-5 P, which is 25 times higher than that of the membrane of 2 M-3 T-2.5 P. The proton conduction in the hybrid membranes appears to originate from the dissociation among the H₃PO₄ molecules in the membranes. Compared with the polymer-H₃PO₄ membranes, the proton conductivity of the new membranes is much higher. For example, at 100° C., the proton conductivity of PBI-2.9H₃PO₄ is about 3×10⁻⁵ S/cm, and that of poly(silamine) (PSA)—H₃PO₄ is in the order of 10⁻⁶ S/cm. In the new membranes, H₃PO₄ exists mainly in free forms, and there is no strong interaction between H₃PO₄ and the polymer backbones to restrict the proton transportation, as in the PBI- or PSA-based membranes. In contrast, the PPO-silicate based hybrid inorganic-organic backbone is helpful to the proton transportation.

Meanwhile, the flexible structure of the hybrid inorganic-organic copolymers supplies large inter-molecular space for the fast proton transportation. The proton conductivities of the membranes with —SO₃H groups are even higher. Comparing Sample a to b in FIG. 10, it was found that the proton conductivity of the membranes increased with increasing —SO₃H group contents. The —SO₃H groups, which are chemically bonded to the aromatic rings, are highly dissociated because of the mesomeric effect of the aromatic ring. The dissociation between —SO₃H groups and H₃PO₄ in the membranes creates more H⁺ defects, and thus increases the proton conductivity. It was reported that the addition of H₂SO₄ to pure H₃PO₄ reduced the proton conductivity because of the increase of viscosity. In the new membranes, H₃PO₄ was dispersed among the hybrid inorganic-organic copolymer framework, and the viscosity change caused by the addition of —SO₃H groups may be too small to affect the proton transport process. However, the —SO₃H group containing membranes become dark after heating in dry atmosphere over 100° C., indicating that —SO₃H containing membranes have limited thermal stability.

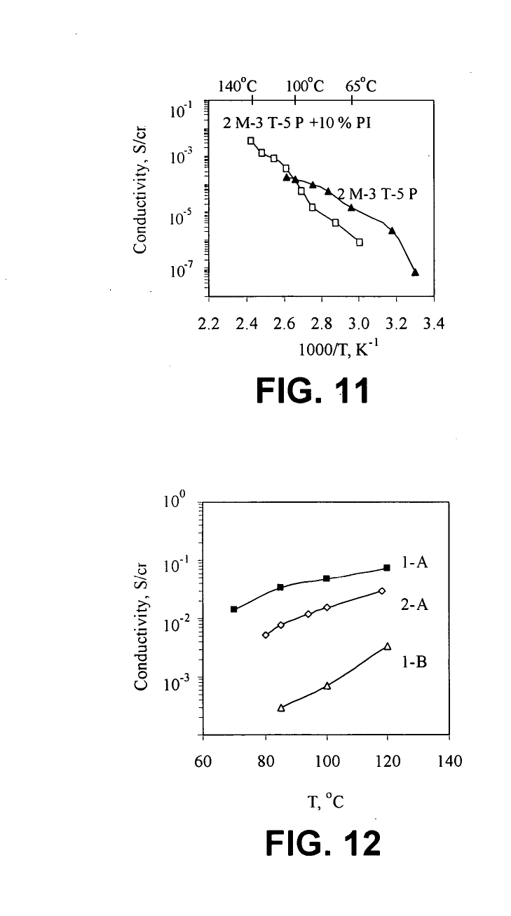

FIG. 11 shows the proton conductivities of a membrane labeled as 2 M-3 T-5 P with 10% PI measured at temperatures from 60° C. to 140° C. It was reported that the proton-transport process between heterocycles, such as imidazole, and the oxo acids follows the Grotthuss-type mechanism. The heterocycles, including imidazole, can dissolve H₃PO₄ instead of water. For example, Nafion membrane with 10% weight of imidazole was reported to have high proton conductivity on the order of 10⁻² S/cm in anhydrous state. It is expected that 2-phenyl imidazole dissolve H₃PO₄, and thus improve the proton conductivity in a dry atmosphere. The proton conductivity of a membrane with a composition of 2 M-3 T-5 P with 10% PI increased with temperature, reaching 3.5×10⁻³ S/cm at 140° C. in a dry atmosphere. This represents the highest proton conductivity value ever reported among solid proton-conducting membranes at this temperature. However, the addition of PI decreased the proton conductivity in the lower temperature range (see FIG. 9). Similar phenomena were observed in PB₁—H₃PO₄-Imidazole system, and were attributed to the increase in viscosity of the membranes. In fact, the proton transportation process in H₃PO₄-imidazole containing polymer or copolymer membranes is very complex, and limited by many factors, including viscosity, inter-molecular space, flexibility of the membranes, the melting temperature of imidazole rings, and others. Further investigation is necessary to understand the mechanism of proton transportation, and design the ideal molecule structures for the high proton conducting membranes.

To check the humidity dependence of the hybrid inorganic-organic membranes, the proton conductivities of the membranes were measured from 80° C. and 120° C. in the water vapor of saturated MgCl₂ or LiCl aqueous solutions in a nearly-closed chamber. The calculated relative humidity in the closed chamber with saturated MgCl₂ aqueous solution is 26% at 80° C. and about 20% at 100° C., and that with saturated LiCl aqueous solution is 11% at 80° C. and about 10% at 100° C. The samples were kept for several hours before conductivity measured until the measured values were stable. The proton conductivities of two samples were presented in FIG. 12. As expected, the proton conductivity of the new membranes is very much sensitive to humidity. At 100° C., the proton conductivity of the sample with a composition of 2 M-2 Oc-1 T-5H₃PO₄ increased from 7.0×10⁻⁴ S/cm in RH 10% to 4.7×10⁻² S/cm in RH 20%. This can be attributed to the fast transport of H₃O⁺ as a vehicle of protons. The proton conductivities of the two measured samples increase with temperature, and reach 3.0×10⁻² S/cm and 7.2×10⁻² S/cm at 120° C. for the samples with a composition of 2 M-2 Oc-1 T-3H₃PO₄ and 2 M-2 Oc-1 T-5H₃PO₄, respectively, indicating that the new membranes are promising candidates as the electrolyte of high-temperature PEM fuel cells and direct methanol fuel cell (DMFC) in low relative humidity.

### CONCLUSION

Bis(3-methyldimethyoxysilyl)polypropylene oxide (MDSPPO) is a good network former for the hybrid inorganic-organic copolymer membranes. The obtained membranes are like plastic with good mechanical strength and high thermal stability. The proton conductivities are over 10⁻² S/cm in the measured temperature range from 80° C. to 120° C. in low relative humidity (<25%). Further, they can be readily made in large size with a thickness of 0.1 mm or less. The new membranes have great potential as a candidate for electrolytes of PEM fuel cells, direct methanol fuel cells (DMFC), as well as other electrochemical devices operated above 100° C. in low relative humidity. The thermal stability of MDSPPO-based hybrid inorganic-organic copolymers can be reduced by incorporating —SO₃H groups. Heterocyles, including imidazole ring, can be introduced into the hybrid inorganic-organic copolymer membranes to further improve the proton conductivity.

It should be emphasized that the above-described embodiments of this disclosure are merely possible examples of implementations, and are set forth for a clear understanding of the principles of this disclosure. Many variations and modifications may be made to the above-described embodiments of this disclosure without departing substantially from the spirit and principles of this disclosure. All such modifications and variations are intended to be included herein within the scope of this disclosure and protected by the following claims.

Therefore, at least the following is claimed:

1. A membrane, comprising:
a flexible proton electrolyte membrane having the characteristic of a proton conductivity of about 1×10⁻⁶ to 1×10⁻¹ S/cm at a temperature range of about 30° C. to about 180° C. and a relative humidity of about 0% to 100%.

2. A fuel cell, comprising:
a flexible proton electrolyte membrane having the characteristic of a proton conductivity of about 1×10⁻⁶ to 1×10⁻¹ S/cm at a temperature range of about 30° C. to about 180° C. and a relative humidity of about 0% to 100%; with the proviso that the fuel cell does not include a humidifier, a catalyst, and a thermal management system for controlling the temperature in the fuel cell.

3. A flexible proton electrolyte membrane, comprising:
a hybrid inorganic-organic copolymer network having at least one backbone unit having a formula [—O—Si(WX)—O—Si(YZ)-R¹—], wherein each of W, X, Y, and Z is selected from —OPO₃H₂, —R²A, —R³, —O—, and —OPO₃H₂, and wherein R¹, R², and R³ are each hydrocarbons.

4. The membrane of claim 3, wherein R¹ is selected from a linear C₂ to C₂₀ hydrocarbon, a branched C₂ to C₂₀ hydrocarbon, a halogen-substituted linear C₂ to C₂₀ hydrocarbon, and a halogen-substituted branched C₂ to C₂₀ hydrocarbon.

5. The membrane of claim 3, wherein R² is selected from a linear C₂ to C₂₀ hydrocarbon, a branched C₂ to C₂₀ hydrocarbon, a hydrocarbon including an aromatic ring, a halogen-substituted linear C₂ to C₂₀ hydrocarbon, a halogen-substituted branched C₂ to C₂₀ hydrocarbon, and a halogen-substituted hydrocarbon including an aromatic ring.

6. The membrane of claim 3, wherein R³ is selected from CH₃ and C₂H₅.

7. The membrane of claim 3, wherein A is selected from —SO₃H, SO₂NHSO₂CF₃, —CF₂SO₃H, and —CF₂SO₂NHSO₂CF₃.

8. The membrane of claim 3, wherein the backbone unit is crosslinked with a second backbone unit.

9. The membrane of claim 3, wherein each of W, X, Y, and Z are different.

10. The membrane of claim 3, wherein the backbone unit has a formula [—O—Si(WX)—O—Si(YZ)-R¹—O—R⁴], wherein each of W, X, Y, and Z is selected from, —R²A, —R³, —O—, and —OPO₃H₂, wherein R⁴ is a hydrocarbon.

11. The membrane of claim 10, wherein R⁴ is selected from a linear C₂ to C₂₀ hydrocarbon, a branched C₂ to C₂₀ hydrocarbon, a halogen-substituted linear C₂ to C₂₀ hydrocarbon, and a halogen-substituted branched C₂ to C₂₀ hydrocarbon.

12. The membrane of claim 3, wherein the backbone unit has a formula [—O—Si(WX)—O—Si(YQ)-R¹—Si(YQ)-], wherein each of W, X, and Y is selected from —OPO₃H₂, —R²A, —R³, —OPO₃H₂, wherein Q includes —O—S¹—R⁸—Si— wherein R² and R³ are each hydrocarbons, wherein each of R¹ and R⁸ are selected from a short chain hydrocarbon and a long chain hydrocarbon, wherein R¹ and R⁸ are different, wherein the short chain hydrocarbon is selected from a linear C₂ to C₂₀ hydrocarbon, a branched C₂ to C₂₀ hydrocarbon, a halogen-substituted linear C₂ to C₂₀ hydrocarbon, and a halogen-substituted branched C₂ to C₂₀ hydrocarbon, and wherein a long chain hydrocarbon is selected from a hydrocarbon having a molecular weight from about 500 to 100,000 and a halogen-substituted hydrocarbon having a molecular weight from about 500 to 100,000.

13. The membrane of claim 3, wherein the membrane is incorporated in a fuel cell.

14. A membrane formed from mixing components comprising:
at least one hybrid inorganic-organic copolymer network former compound;
a first compound including an inorganic acid group;
a Si—O—Si inorganic backbone former compound; and
a H₃PO₄ compound.

15. The membrane of claim 14, wherein the inorganic acid group is selected from —SO₃H, —SO₂NHSO₂CF₃, —CF₂SO₃H, and —CF₂SO₂NHSO₂CF₃.

16. The membrane of claim 14, wherein the hybrid inorganic-organic copolymer network former compound includes an epoxide ring containing alkoxysilane compound.

17. The membrane of claim 16, wherein the epoxide ring containing alkoxysilane compound is selected from an aliphatic epoxide ring containing alkoxysilane compound and a cycloaliphatic epoxide ring containing alkoxysilane compound.

18. The membrane of claim 17, wherein the epoxide ring containing alkoxysilane compound is selected from (D₃₋ₓMₓ)SiR⁵C₂H₃O and (D₃₋ₓMₓ)SiR⁵C₆H₉O, wherein D can be selected from C₂H₅O and CH₃O, M is selected from C₂H₅ and CH₃, R⁵ is a C₂ to C₂₀ hydrocarbon chain, and x is from 0 to 2.

19. The membrane of claim 17, wherein the epoxide ring containing alkoxysilane compound is selected from (3-glycidoxypropyl)methyldiethoxysilane, (3-glycidoxypropyl)methyldimethoxysilane, (3-glycidoxypropyl)triethoxysilane, (3-glycidoxypropyl)trimethoxysilane, 5,6-epoxyhexyltriethoxysilane, 5,6-epoxyhexyltrimethoxysilane, 2-(3,4-epoxycyclohexyl)ethyltriethoxysilane, and 2-(3,4-epoxycyclohexyl)ethyltrimethoxysilane.

20. The membrane of claim 14, wherein the hybrid inorganic-organic copolymer network former is selected from an aliphatic diepoxide monomer and a cycloaliphatic diepoxide monomer.

21. The membrane of claim 20, wherein the hybrid inorganic-organic copolymer network former is selected from (C₂H₃O)R⁶(C₂H₃O) and C₆H₉OR⁶C₆H₉O, wherein R is a C₂ to C₂₀ hydrocarbon chain.

22. The membrane of claim 20, wherein the hybrid inorganic-organic copolymer network former is selected from 1,3-butadiene diepoxide, dicyclopentadiene diepoxide, and 3,4-epoxycyclohexylmethyl-3,4,-epoxy-cyclohexanecarboxylate.

23. The membrane of claim 14, wherein first compound including an inorganic acid group includes (D₃₋ₓMₓ)SiR⁷A, wherein D can be selected from C₂H₅O and CH₃O, M is selected from C₂H₅ and CH₃, R⁷ is a C₂ to C₂₀ hydrocarbon chain, x is from 0 to 2, and wherein A is an inorganic acid group is selected from —SO₃H, —SO₂NHSO₂CF₃, —CF₂SO₃H, and —CF₂SO₂NHSO₂CF₃.

24. The membrane of claim 14, wherein the first compound including an inorganic acid group is selected from sulfonated phenyltriethoxysilane (SPS), sulfonated phenylethyltriethoxysilane, and 3-(trihydroxysilyl)-1-propane sulfonic acid.

25. The membrane of claim 14, wherein the Si—O—Si inorganic backbone former compound is selected from tetraethoxysilane and tetramethoxysilane.

26. The membrane of claim 14, wherein the hybrid inorganic-organic copolymer network former compound is from about 20 to 80 mole ratio of the membrane, the first compound including an inorganic acid functional group is from about 0 to 20 mole ratio of the membrane, the Si—O—Si inorganic backbone former compound is from about 20 to 80 mole ratio of the membrane, and the H₃PO₄ compound is about 0.1 to 1.5 times the total Si moles in the membrane.

27. A membrane formed from mixing components comprising:
a bis(alkylalkoxysilyl)-terminated polymer compound;
a bis(trialkoxysilyl)-terminated short organic chain compound;
a first compound including an inorganic acid group;
a Si—O—Si inorganic backbone former compound; and
a H₃PO₄ compound.

28. The membrane of claim 27, further comprising a heterocycle compound.

29. The membrane of claim 28, wherein the imidazole-ring containing compound is selected from imidazole, benzimidazole, 2-phenyl imidazole (PI), 2-methyl 4-ethyl imidazole, and imidazole-2-carboxaldehyde.

30. The membrane of claim 27, wherein the bis(alkylalkoxysilyl)-terminated polymer compound includes (D₃₋ₓMₓ)SiR⁹Si (D₃₋ₓMₓ), wherein D can be selected from C₂H₅O and CH₃O, M is selected from C₂H₅ and CH₃, R⁹ is a linear C₂ to C₂₀ hydrocarbon chain, and x is from 1 to 2.

31. The membrane of claim 30, wherein the bis(alkylalkoxysilyl)-terminated polymer compound is selected from bis((3-methyldimethoxysilyl)propyl)polypropylene oxide, bis((3-methyldimethoxysilyl)propyl)polytetraethylene oxide, bis(methyldimethoxysilyl)poly(1-butene), bis(methyldimethoxysilyl)polyethylene, bis(dimethylmethoxysilyl)polyethylene, bis(methyldimethoxysilyl)polypropylene, bis(methyldimethoxysilyl)polyvinylidene fluoride, bis(methyldimethoxysilyl)polystyrene, bis(methyldimethoxysilyl)polytetrafluoroethylene, bis(methyldimethoxysilyl)polyvinyl chloride, and bis(methyldimethoxysilyl)polyvinyl alcohol.

32. The membrane of claim 27, wherein the bis(trialkoxysilyl)-terminated short organic chain compound includes (D₃)SiR¹⁰Si (D₃), wherein D can be selected from C₂H₅O and CH₃O, R¹⁰ is a linear C₂ to C₂₀ hydrocarbon chain, and x is from 1 to 2.

33. The membrane of claim 32, wherein the bis(alkylalkoxysilyl)-terminated polymer compound is selected from bis(triethoxysilyl)ethane, bis(triethoxysilyl)octane, bis(triethoxysilyl)nonane, bis(triethoxysilyl)methane, bis(triethoxysilylethyl)benzene, bis(triethoxysilyl)hexane, bis(trimethoxysilylpropyl)amine, bis[(trimethoxysilyl)propyl)]ethylenediamine, bis(trimethoxysilyl)ethane, bis(trimethoxysilyl)octane, bis(trimethoxysilyl)nonane, bis(trimethoxysilyl)methane, bis(trimethoxysilylethyl)benzene, and bis(trimethoxysilyl)hexane.

34. The membrane of claim 27, wherein the first compound including an inorganic acid group includes (D₃₋ₓMₓ)SiR¹¹A, wherein D can be selected from C₂H₅O and CH₃O, M is selected from C₂H₅ and CH₃, R¹¹ is a C₂ to C₂₀ hydrocarbon chain, x is from 0 to 2, and wherein A is an inorganic acid group is selected from —SO₃H, —SO₂NHSO₂CF₃, —CF₂SO₃H, and —CF₂SO₂NHSO₂CF₃.

35. The membrane of claim 27, wherein the first compound including an inorganic acid group is selected from sulfonated phenyltriethoxysilane (SPS), sulfonated phenylethyltriethoxysilane, and 3-(trihydroxysilyl)-1-propane sulfonic acid.

36. The membrane of claim 27, wherein the Si—O—Si inorganic backbone former compound is selected from tetraethoxysilane and tetramethoxysilane.

37. The membrane of claim 27, wherein the membrane includes about 1 to 2 moles of Si derived from the bis(alkylalkoxysilyl)-terminated polymer compound, about 0 to 3 moles of Si derived from the bis(trialkoxysilyl)-terminated short organic chain compound, about 0 to 3 moles of Si derived from the first compound including an inorganic acid group, about 0 to 2 moles of Si derived from the Si—O—Si inorganic backbone former compound, and wherein about 10% to 150% of the moles of Si from the bis(alkylalkoxysilyl)-terminated polymer compound, bis(trialkoxysilyl)-terminated short organic chain compound, the first compound including an inorganic acid group, the Si—O—Si inorganic backbone former compound, equals the moles of H₃PO₄.

38. The membrane of claim 28, wherein the membrane includes about 1 to 2 moles of Si derived from the bis(alkylalkoxysilyl)-terminated polymer compound, about 0 to 3 moles of Si derived from the bis(trialkoxysilyl)-terminated short organic chain compound, about 0 to 3 moles of Si derived from the first compound including an inorganic acid group, about 0 to 2 moles of Si derived from the Si—O—Si inorganic backbone former compound, about 50% to 100% of the moles of Si from the bis(alkylalkoxysilyl)-terminated polymer compound, bis(trialkoxysilyl)-terminated short organic chain compound, the first compound including an inorganic acid group, the Si—O—Si inorganic backbone former compound, equals the moles of H₃PO₄, and about 0% to 50% of the moles of H₃PO₄ equals the moles of the heterocyle compound.

39. A method of preparing a membrane comprising:
providing a sol mixture, wherein the sol mixture is from formed by mixing compounds selected from group 1 or group 2, wherein group 1 comprises at least one hybrid inorganic-organic copolymer network former compound, a first compound including an inorganic acid group, a Si—O—Si inorganic backbone former compound, and a H₃PO₄ compound, and group 2 comprises a bis(alkylalkoxysilyl)-terminated polymer compound, a bis(trialkoxysilyl)-terminated short organic chain compound, a first compound including an inorganic acid group, a Si—O—Si inorganic backbone former compound, and a H₃PO₄ compound;
disposing the mixture on a substrate;
heating the mixture; and
forming a flexible proton electrolyte membrane having the characteristic of a proton conductivity of about 1×10⁻⁶ to 1×10⁻¹ S/cm at a temperature range of about 30° C. to about 180° C. and a relative humidity of about 0% to 100%.
